(19) United States
(12) Patent Application Publication
(10) Pub. No.: US 2003/0173529 A1
(43) Pub. Date: Sep. 18, 2003

(54) Mask pattern inspection system and mask pattern-inspecting method

(75) Inventor: Eiichi Hoshino, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/352,007

(22) Filed: Jan. 28, 2003

(30) Foreign Application Priority Data
Mar. 14, 2002 (JP) 2002-069541

(51) Int. Cl. G01V 8/00; G01N 21/86

(52) U.S. Cl. 250/559.42

(57) ABSTRACT

There is provided a mask pattern inspection system for detecting a defect candidate of a mask pattern and determining whether or not the defect candidate indicates a true defect. An image-recording section records a defect-detecting image obtained by a confocal microscope, and a defect candidate-detecting section extracts only a G signal from RGB signals included in the defect-detecting image to thereby detect a defect candidate. This makes it possible to detect the defect candidate from the defect-detecting image with accuracy. Further, a pattern data-processing section carries out an FIR filtering process on pattern data used for designing the mask to convert the pattern data to inspecting image data, and compares the defect-detecting image and the inspecting image data with each other. In this process, the inspecting image data is formed by the conversion such that it is adapted in image condition to the defect-detecting image, whereby it is possible to determine whether or not the defect candidate detected from the defect-detecting image indicates a true defect.

### CROSS-REFERENCE TO RELATED APPLICATIONS

This application is based upon and claims the benefit of priority from the prior Japanese Patent Application No. 2002-69541, filed in Mar. 14, 2002, the entire contents of which are incorporated herein by reference.

### BACKGROUND OF THE INVENTION

(1) Field of the Invention

This invention relates to a mask pattern inspection system and mask pattern-inspecting method, and more particularly to a mask pattern inspection system and mask pattern-inspecting method for inspecting a mask pattern formed on an exposure mask for defects.

(2) Description of the Related Art

In a semiconductor device-manufacturing process, a transmissive mask or a reflective mask is used, and a mask pattern formed on the mask is transferred to a wafer by a reduction projection exposure system. Recently, this lithography step is carried out by using radiation at a wavelength in an Extreme Ultra-Violet (EUV) region, and a reflective mask is widely used in this step.

The reflective mask includes a wafer of low-expansion glass or silicon (Si) as a base material, and a film formed on the wafer, which reflects nearly 70% of light irradiated from an EUV light source provided that the light has a wavelength of 13.5 nm. This film is a multilayer film formed by sequentially depositing 40 to 60 pairs of layers of molybdenum (Mo) and silicon. On the multilayer film is deposited a buffer layer of silicon dioxide (SiO₂), and further on the buffer layer a tantalum (Ta) layer as an absorber layer.

When a mask pattern is formed on a substrate of the reflective mask constructed as above, for instance, first, a photosensitive resin is coated on the substrate, and then a desired pattern adapted to a reduction factor of the reduction projection exposure system is drawn by electron-beam lithography. Then, the pattern is developed to thereby process the resin into an etching mask. The absorber layer and the buffer layer are selectively etched using the etching mask, and then the etching mask is removed.

After the reflective mask has been formed as above, the pattern of the absorber layer and portions of the multilayer film exposed below the absorber layer are observed from a top surface side of the mask as an image magnified by an optical microscope so as to inspect the mask for etching residues of the absorber layer and the buffer layer on the mask, defects of the formed pattern, and foreign matter attached to the mask. In this inspection, in order to recognize as fine a pattern shape as possible, an image is obtained by using a probe beam having a wavelength e.g. of 266 nm in a DUV (Deep Ultra-Violet) wavelength region. The thus obtained image is used to sequentially compare corresponding portions of the original and formed patterns with each other, whereby defect candidates are detected as defects.

However, in the conventional method of inspecting the reflective mask, it is difficult to recognize a pattern accurately even with inspection light within the DUV wavelength region, for the following reason:

Assuming, for instance, that a reduction factor of projection with which a reflective mask is formed is one fifth, it is necessary to set the minimum pattern line width of the reflective mask to 250 nm or smaller. At this time, the tolerable size of a defect is expected to be approximately 50 nm on the reflective mask. However, a resolution Res of an image of an object is defined by an equation: Res=λ/NA (λ: wavelength of inspection light; NA: numerical aperture of an objective lens of an inspecting optical system). Therefore even if NA is set to 0.85, only an object having a size of approximately 300 nm can be recognized when using inspection light having a wavelength of 266 nm or so.

Sites detected as abnormal not only indicate true defects, such as etching residues of the absorber layer and the buffer layer, which are produced during generation of the mask pattern, foreign matter attached to the mask, or defects of the formed pattern itself, but also sometimes indicate traces of the mask pattern formed as intended. Therefore, when the resolution is low, it is impossible to detect a minute defect, or determine whether or not a detected defect candidate indicates a true defect.

### SUMMARY OF THE INVENTION

The present invention has been made in view of these circumstance, and an object thereof is to provide a mask pattern inspection system and mask pattern-inspecting method which is capable of detecting a defect candidate on a mask with accuracy and determining whether or not the defect candidate indicates a true defect.

To attain the above object, there is provided a mask pattern inspection system for inspecting a mask pattern formed on a mask. The mask pattern inspection system is characterized by comprising an optical system for irradiating white light emitted from a light source irradiating white light onto the mask and focusing reflected light from the mask, an image-recording section for recording a defect-detecting image obtained from the reflected light focused by the optical system, a defect candidate-detecting section for detecting a defect candidate from the defect-detecting image recorded in the image-recording section, a pattern data-processing section for carrying out a filtering process on pattern data used for designing the mask to convert the pattern data to inspecting image data adapted in image condition to the defect-detecting image, and an image comparison section for comparing the defect-detecting image and the inspecting image data with each other.

Further, to attain the above object, there is provided a mask pattern-inspecting method for inspecting a mask pattern formed on a mask. The mask pattern-inspecting method is characterized by comprising the steps of irradiating white light emitted from a light source onto the mask and focusing reflected light from the mask, recording a defect-detecting image obtained from the reflected light, detecting a defect candidate from the recorded defect-detecting image, carrying out a filtering process on pattern data used for designing the mask to convert the pattern data to inspecting image data adapted in image condition to the defect-detecting image, and comparing the defect-detecting image and the inspecting image data with each other.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing an example of the arrangement of a mask pattern inspection system;

FIGS. 2(A) to 2(D) are diagrams showing an example of a mask-forming method, in which:

FIG. 2(A) shows a step of depositing layers;

FIG. 2(B) shows an etching mask-forming step;

FIG. 2(C) shows a plasma etching step; and

FIG. 2(D) shows a wet etching step;

FIG. 3 is a diagram showing a flow of a process carried out by a defect candidate-detecting section;

FIG. 4 is a diagram showing a flow of a process carried out by a pattern data-processing section;

FIG. 5 is a diagram showing a flow of a process carried out by an image comparison section;

FIGS. 6(A) and 6(B) are diagrams showing an example of a scalar robot, in which:

FIG. 6(A) is a plan view of the scalar robot;

FIG. 6(B) is a side view of the same;

FIGS. 7(A) to 7(C) are diagrams useful in explaining an operation of the scalar robot, in which:

FIG. 7(A) shows a state of the scalar robot before it starts a mask-moving operation;

FIG. 7(B) shows a state of the scalar robot during execution of the mask-moving operation; and

FIG. 7(C) shows a state of the scalar robot after it has terminated its mask-moving operation; and

FIG. 8 is a diagram useful in explaining a method of scanning a surface of a mask.

### DESCRIPTION OF THE PREFERRED EMBODIMENT

The invention will now be described in detail with reference to the drawings showing a preferred embodiment thereof. In the description, a case is taken as an example, where a mask pattern formed on a reflective mask is inspected by using a confocal optical system.

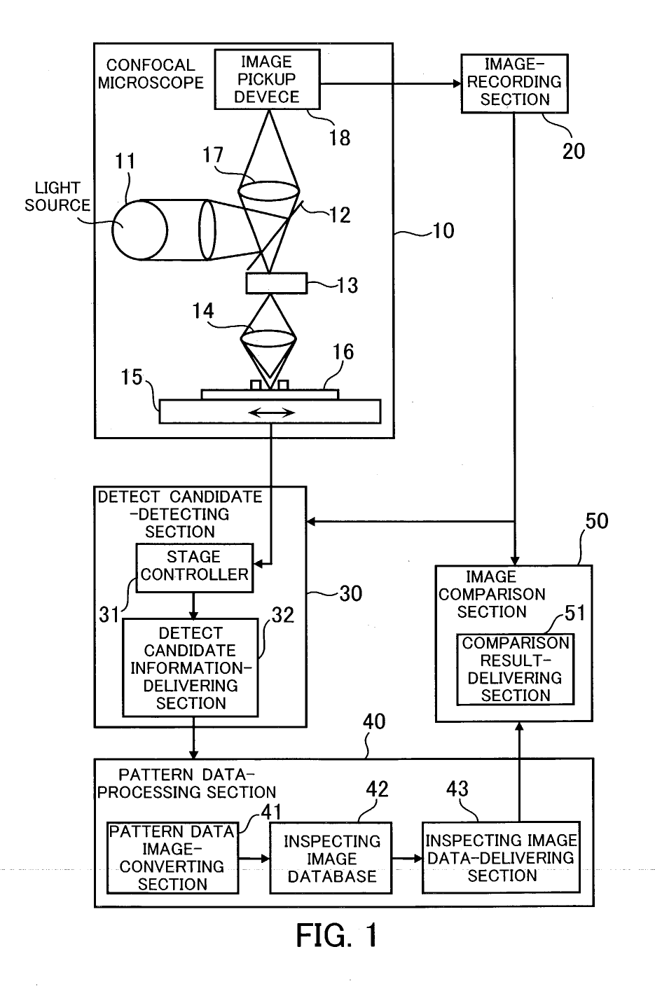

FIG. 1 is a diagram showing an example of the arrangement of a mask pattern inspection system.

The mask pattern inspection system includes a confocal microscope 10, an image-recording section 20, a defect candidate-detecting section 30, a pattern data-processing section 40, and an image comparison section 50.

For the confocal microscope 10 of the mask pattern inspection system, there is employed a 38 μm Pinhole Nipkow Disk Scan Intermediate Lens Barrel (manufactured by Olympus Optical Co., Ltd.) as the confocal optical system. The confocal microscope 10 includes a white light source 11 and inspection light emitted from the light source 11 enters a Nipkow disk 13 via a half mirror 12. The Nipkow disk 13 is formed with a large number of pinholes having a diameter of 38 μm, and the inspection light incident on the rotating Nipkow disk 13 passes through the pinholes to form ideal spherical waves.

The inspection light having left the pinholes passes through an objective lens 14 having a magnification factor of 100, and then hits a mask 16 to be inspected which is placed on a stage 15 of the confocal microscope 10, which is movable in a horizontal direction (X-Y direction).

Light reflected from the mask 16 passes through the objective lens 14 and the Nipkow disk 13 again, transmits through the half mirror 12, and then is focused by an intermediate lens 17 having a magnification factor of 1.6 to form a mask pattern image on an image pickup device 18. In this embodiment, the image pickup device 18 is implemented by a ⅔-inch CCD (Charge Coupled Device).

The image obtained as above is recorded in the image-recording section 20 as a defect-detecting image for comparison with inspecting image data, referred to hereinafter, which is produced based on CAD data used for designing the mask pattern of the mask 16.

Further, the defect candidate-detecting section 30 detects a defect candidate on the mask pattern by using the defect-detecting image recorded in the image-recording section 20. The defect candidate-detecting section 30 includes a stage controller 31 for controlling the horizontal movement of the stage 15 of the confocal microscope 10. When a defect candidate is detected in a defect-detecting image, the coordinates of the defect candidate are located and data of the coordinates is delivered from a defect candidate information-delivering section 32 to the pattern data-processing section 40, as defect candidate information.

The pattern data-processing section 40 includes a pattern data image-converting section 41 for converting the CAD data used for designing the mask pattern to the inspecting image data for comparison with the defect-detecting image recorded in the image-recording section 20. The inspecting image data converted from the CAD data by the pattern data image-converting section 41 is stored in an inspecting image database 42. An inspecting image data-delivering section 43 uses defect candidate information delivered from the defect candidate-detecting section 30 to deliver an inspecting image data item corresponding to the coordinates of the defect candidate, which is selected out of the inspecting image data items stored in the inspecting image database 42, to the image comparison section 50.

The image comparison section 50 compares or checks a defect-detecting image recorded in the image-recording section 20 with the inspecting image data item delivered from the pattern data-processing section 40, and outputs the result of the comparison to a comparison result-delivering section 51.

By using the mask pattern inspection system, the mask pattern of the mask 16 is inspected for defects.

First, a method of forming the mask 16, which is an object to be inspected, will be described hereinafter.

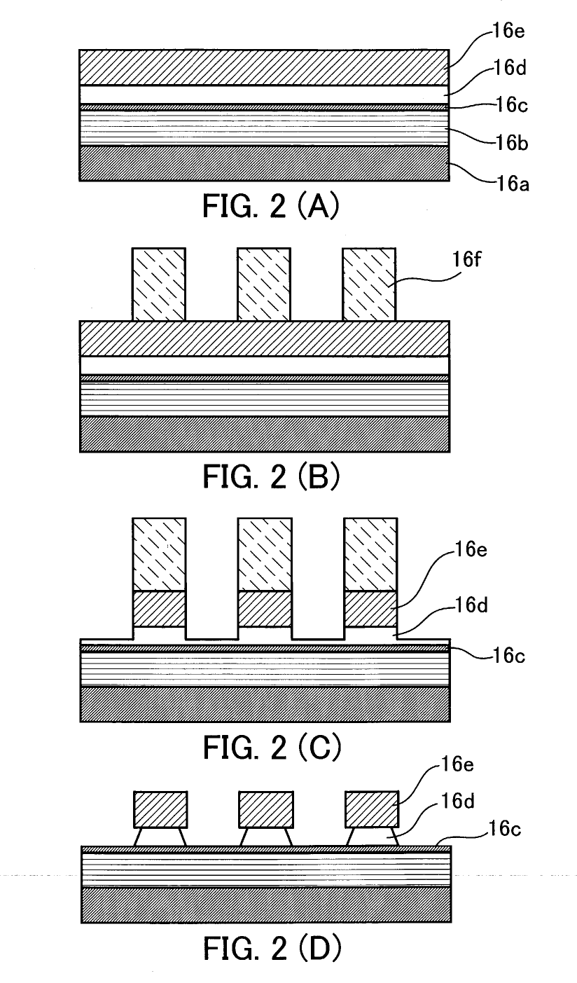

FIGS. 2(A) to 2(D) are diagrams showing an example of the mask-forming method, in which FIG. 2(A) shows a step of depositing layers, FIG. 2(B) shows an etching mask-forming step, FIG. 2(C) shows a plasma etching step, and FIG. 2(D) shows a wet etching step.

As shown in FIG. 2(A), a multilayer film 16b is formed on a silicon substrate 16a by alternately depositing layers of Mo and Si each with a thickness of 6.9 nm. This multilayer film 16b has 40 pairs of layers of Mo and Si.

On the topmost layer of the multiplayer film 16b, there is formed a protective layer 16c of amorphous silicon having a thickness of 8 nm.

On the protective layer 16c is formed a SiO₂ buffer layer 16d by depositing SiO₂ to a thickness of 40 nm by a RF magnetron sputtering method. Further, on the SiO₂ buffer layer 16d, there is formed a Ta absorber layer 16e by depositing Ta to a thickness of 100 nm by a DC magnetron sputtering method. It should be noted that since Ta has a columnar crystal structure, sputtered Ta particles sometimes enter the SiO₂ buffer layer 16d thereunder to form a mixed layer having a thickness of 1 nm or less.

After deposition of the films, to form an etching mask, as shown in FIG. 2(B), the Ta absorber layer 16e is coated with a resist 16f (“ZEP 7000” manufactured by Zeon Corporation) to a thickness of 330 nm by a spin coating method, and baked on a hot plate at 150° c. for three minutes. Then, a pattern for use in forming a mask pattern having a line width of 0.28 μm is drawn on the resist 16f by electron-beam lithography, and then developed with a developer (“ZED 500” manufactured by Zeon Corporation) and a rinse solution (methyl isobutyl ketone) by a spin developing method, to form the etching mask.

After the development, the exposed Ta absorber layer 16e is etched until the surface of the SiO₂ buffer layer 16d is exposed, by plasma etching with a mixed gas of chlorine (Cl₂) and boron trichloride (BCl₃) (mixture ratio: Cl₂:BCl₃=1:4) at a pressure of 1 Pa. Further, as shown in FIG. 2C, the SiO₂ buffer layer 16d is etched to such an extent that the surface of the protective layer 16c is not exposed, by plasma etching with a mixed gas of argon (Ar), octafluorobutane (C₄F₈), and oxygen (mixture ratio: Ar:C₄F₈:O₂=20:1:2) at a pressure of 1 Pa.

After the plasma etching, the SiO₂ buffer layer 16d is immersed in an aqueous solution of hydrogen fluoride diluted to a concentration of 3.3%. For instance, to form a SiO₂ buffer layer 16d having a remaining film thickness of 4.6 nm, the SiO₂ buffer layer 16d is immersed in the 3.3% aqueous solution of hydrogen fluoride for 30 seconds. This produces a pattern shape of the SiO₂ buffer layer 16d having an excellent sidewall angle, as shown in FIG. 2(D). Finally, the resist 16f is removed by ashing with a gas plasma of Ar and O₂ to form the mask pattern having a line width of 0.28 μm.

The mask pattern thus formed is inspected by using the mask pattern inspection system shown in FIG. 1 for defects which may be formed therein during the manufacturing process described above. In the following, a method of inspecting the mask pattern will be described in detail.

To inspect the mask pattern, first, the mask 16 is placed on the stage 15 of the confocal microscope 10. In this embodiment, a Xenon (Xe) lamp is used as the light source 11, and inspection light emitted from the light source 11 is caused to hit the rotating Nipkow disk 13 via the half mirror 12. By passing through the pinholes of the Nipkow disk 13, the inspection light is formed into spherical waves, passes through the objective lens 14, and hits the mask 16. Light reflected from the mask 16 passes through the objective lens 14, the Nipkow disk 13, and the half mirror 12 in the mentioned order, and is focused by the intermediate lens 17, to form a mask pattern image on the image pickup device 18.

Here, dispersion of the reflected light occurring when passing through the objective lens 14, causes chromatic aberration i.e. phenomenon of the focal point varying with the wavelength of light. This results in displacement of image-forming positions. If this displacement is utilized, it is possible to substantially equalize the intensities of images simultaneously reflected from a protruded portion and a recessed portion of the mask pattern different in level or height. By using this technique, the intensity of light scattered at contour portions of the mask pattern can be reduced.

If the image of the mask pattern is observed in such a condition, as for a defect candidate where the distance between adjacent traces of a pattern is different from that of traces of the intended or designed mask pattern which should be linearly laid out on the mask 16, light scattered therefrom can be observed which has wavelengths different from those of light reflected from the neighboring area.

In view of the above fact, the focus is reduced by approximately 0.5 μm such that contrast between the surface of the Ta absorber layer 16e as the protruded portion of the mask pattern of the mask 16 shown in FIG. 2(D) and the surface of the protective layer 16c as the recessed portion of the same is reduced to thereby increase the gain of the CCD of the image pickup device 18. More specifically, the objective lens 14 is focused on the surface of the Ta absorber layer 16e as the protruded portion of the mask pattern to reduce the influence of the light reflected from the surface of the protective layer 16c as the recessed portion of the mask pattern. This makes it possible to substantially equalize the intensities of reflected light from the protruded portion and reflected light from the recessed portion of the mask pattern. As a result, the figure of the whole image is blurred, making the contour of the mask pattern unclear, while a defect candidate produces scattered light having different wavelengths from those of reflected light from the surrounding area.

In this embodiment, images are obtained at a rate of 18 frames per second each covering a mask surface of 75 μm by 100 μm and a size of 640 by 480 pixels. The obtained images are recorded as defect-detecting images in the image-recording section 20.

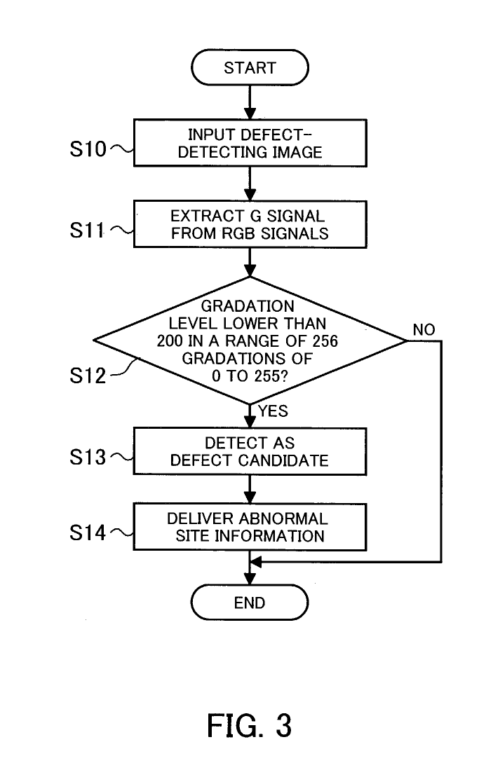

FIG. 3 shows a flow of a process carried out by the defect candidate-detecting section.

When a defect-detecting image recorded in the image-recording section 20 is inputted to the defect candidate-detecting section 30 in a step S10, only a G signal is taken out from RGB signals of the defect-detecting image in a step S11. Then, it is determined in a step S12 whether or not the G signal taken out from the defect-detecting image presents a gradation level lower than 200 within a range of 256 gradations of 0 to 255 for any site, and a site lower than 200 in gradation level is detected as a defect candidate in a step S13. The data coordinates representative of the detected defect candidate are delivered as defect candidate information from the defect candidate information-delivering section 32 to the pattern data-processing section 40 in a step S14. Further, if it is determined in the step S12 that the G signal represents gradation levels 200 or higher for all sites, it is judged that there is no defect candidate, followed by terminating the program.

It should be noted that as a reference value set to the gradation level 200 in the above example is set closer to 255, a smaller defect candidate can be detected. Therefore, to enhance detecting accuracy of the apparatus, the system may be configured such that a band-pass filter is arranged for transmitting only wavelengths close to the G signal therethrough before the image pickup device 18 of the confocal microscope 10 shown in FIG. 1 receives reflected light. Further, if the inspection light emitted from the light source 11 set for use contains lots of radiations having wavelengths shorter than that of a radiation (green light) represented by the G signal, by selecting a focal position again, a similar defect candidate-detecting process as described above can be carried out in a manner adapted to the radiations of the shorter wavelengths. Further, similarly to the above, it is possible to cope with a case where the inspection light contains lots of radiations having wavelengths longer than that of green light.

Abnormal sites detected as above not only indicate true defects, such as etching residues of the Ta absorber layer 16e and the SiO₂ buffer layer 16d, foreign matter attached to the mask 16, or pattern defects, but also sometimes indicate traces of the mask pattern formed as intended. Therefore, it is necessary to determine as to each detected defect candidate whether it indicates a true defect.

As described hereinabove, to detect a defect candidate, the defect-detecting image is in the condition of the contour of the mask pattern being made unclear and light from a defect candidate being scattered with wavelengths different from those of its surrounding area. In order to determine by using the defect-detecting image described above whether or not the detected defect candidate indicates a true detect, the CAD data of the mask pattern to be compared with the defect-detecting image is subjected to an image-converting process by the pattern data-processing section 40.

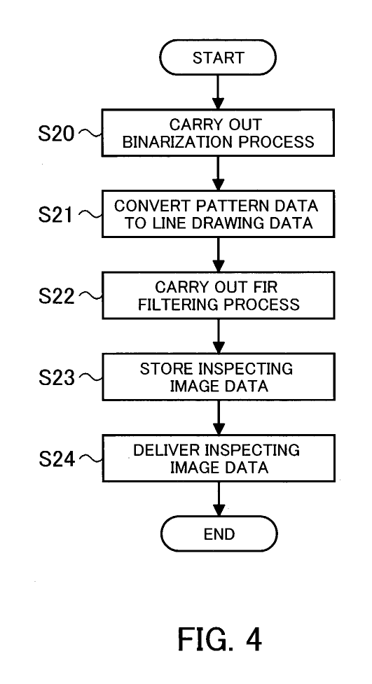

FIG. 4 shows a flow of the image-converting process carried out by the pattern data-processing section 40.

In the pattern data-processing section 40, first, the pattern data image-converting section 41 carries out a binarization process in s step S20 by filling pattern data laid out by a GDS-II stream format with the same color as that used is line drawing. As a result, the pattern data is displayed with all the joint lines drawn by a single-stroke writing method being integrated in a pattern graphic.

Next, divisional areas each having a size of 40 μm vertical by 40 μm horizontal are extracted and converted to line drawing data in a bit map format of 400 pixels high by 400 pixels wide in a step S21. This line drawing data is subjected to an FIR (Finite Impulse Response) filtering process in a step S22. By carrying out the FIR filtering process, the line drawing data is converted to inspecting image data as an impulse response obtained by inputting the line drawing data as an impulse input to a finite cyclic image-processing filter.

In designing the FIR filter used in this embodiment, a sampling frequency is set to 13.5 MHz, a cut-off frequency is set to 3 MHz, and the number of taps of the filter is set to 9. Further, the line drawing data input to be subjected to the filtering processing is converted with respect to X and Y directions on condition that the absolute value of the positive and negative coefficients of a fourth tap is set to 0.5. This conversion causes the inspecting image data to be adjusted to a pattern rule that it should have a line width of 0.28 μm, and contours thereof to be made unclear. Therefore, portions where traces of the pattern are not linearly laid out as intended on design, are also made unclear in contour, forming blurred portions from their surrounding areas with slight color differences. This enables the inspecting image data to be adapted in condition to the defect-detecting image.

The inspecting image data converted by the pattern data image-converting section 41 is stored in the inspecting image database 42 in a step S23.

Then, in a step S24, the pattern data-processing section 40 selects an inspecting image data item, which corresponds to the coordinates indicated by defect candidate information delivered from the defect candidate-detecting section 30, from the inspecting image data items stored in the inspecting image database 42, to output the inspecting image data item to the image comparison section 50.

It should be noted that the converting process carried out by the pattern data image-converting section 41 may be performed by extracting only an area corresponding to coordinates of the defect candidate detected by the defect candidate-detecting section 30. This makes it possible to shorten processing time and reduce the number of data files.

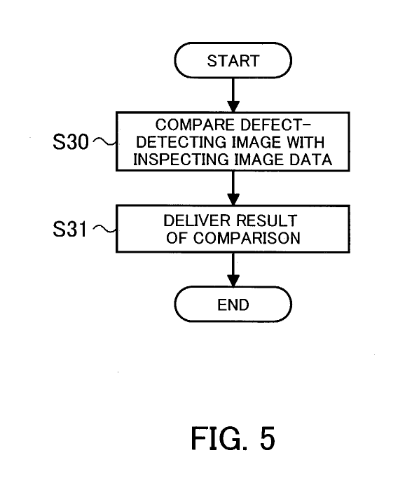

FIG. 5 shows a flow of a process carried out by the image comparison section 50.

In the image comparison section 50, an inspecting image (data item) corresponding to the coordinates of a defect-detecting image containing a defect candidate detected by the defect candidate-detecting section 30, and the defect-detecting image, which is stored in the image-recording section 20, are compared by superposing one image upon the other, in a step S30. Then, the result of the comparison is delivered to the comparison result-delivering section 51 in a step S31.

Based on the result of the comparison, the operator determines whether or not the defect-detecting image and the inspecting image (data item) agree with each other.

Now, if the defect-detecting image and the inspecting image agree with each other, a defect candidate on the defect-detecting image overlaid onto a trance-forming portion on the inspecting image data comes to be observed at a higher intensity level of light. This enables the operator to recognize the defect candidate as a trace of the pattern formed as intended.

On the other hand, if the defect-detecting image and the inspecting image do not agree with each other, a defect candidate on the defect-detecting image overlaid onto a portion which is not the trace-forming portion on the inspecting image comes to be observed at a lower intensity level of light. This enables the operator to recognize the defect candidate as a portion which is not a trace-forming portion, that is, as a defect of the pattern.

As described above, according to the mask pattern-inspecting method of the present invention, a fine defect candidate can be detected with accuracy by properly adjusting the condition of the defect-detecting image. Further, by making the inspecting image data adapted in condition to the defect-detecting image for comparison, the operator can finally determine whether or not the detected defect candidate indicates a true defect.

Although in the above description, the stage 15 is used to horizontally move the mask 16 observed by the confocal microscope 10, this is not limitative, but a scalar robot can be employed in place of the stage 15.

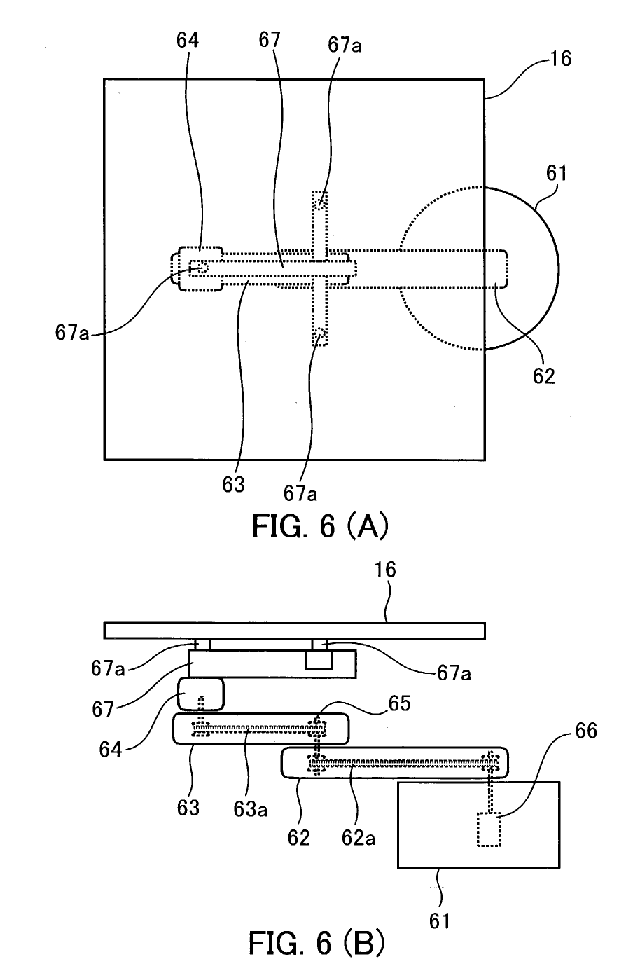

FIGS. 6(A) and 6(B) show an example of the scalar robot. FIG. 6(A) is a plan view of the scalar robot, and FIG. 6(B) is a side view thereof.

The scalar robot includes a rotating mechanism 61, and a lower end portion of the rotating mechanism 61 is rigidly fixed to a body, not shown, of the scalar robot. The scalar robot incorporates a first motor arranged within the body and the rotating mechanism 61 is driven for rotation by a driving force of the first motor about a perpendicular shaft which is perpendicular to a plane on which the scalar robot is installed.

A first arm 62 is arranged on an upper end of the rotating mechanism 61. The first arm 62 has a free end thereof coupled to a second arm 63. The second arm 63 has a free end to which is rotatably attached an arm base 64. A mask-fixing arm 67 is mounted on the arm base 64, for fixing the mask 16 thereto. The mask-fixing arm 67 is provided with vacuum sucking pads 67a with which the mask 16 is fixed. The first arm 62, the second arm 63, and the mask-fixing arm 67 are configured such that they can be rotated in planes parallel to the plane on which the scalar robot is installed, respectively.

The first arm 62 and the second arm 63 contain a first timing belt 62a and a second timing belt 63a, respectively. The first timing belt 62a and the second timing belt 63a are operated in a manner interlocked with each other via a shaft 65 arranged at a coupling portion for coupling the first arm 62 and the second arm 63 to each other. Further, the rotation of the second timing belt 63a is transmitted to the arm base 64.

The rotating mechanism 61 contains a second motor 66, and rotation of the second motor 66 is transmitted to the first timing belt 62a. As a result, the second timing belt 63a is rotated in a manner interlocked with rotation of the first timing belt 62a, to bend the second arm 63, and the arm base 64 is rotated through a predetermined angle in a manner interlocked with the bending operation of the second arm 63.

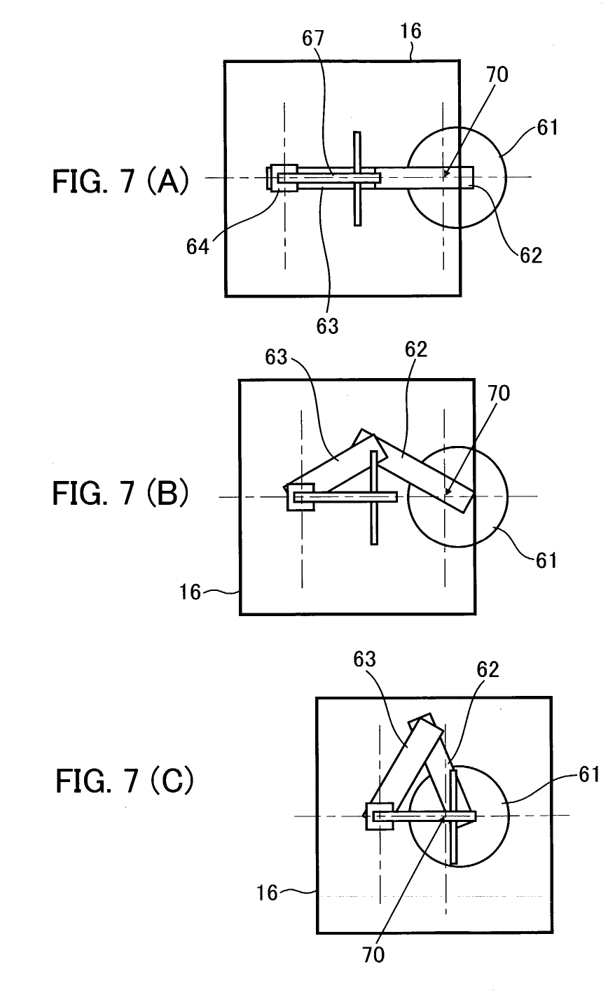

FIGS. 7(A) to 7(C) are diagrams useful in explaining the operation of the scalar robot. FIG. 7(A) shows the state of the scalar robot before it starts a mask-moving operation; FIG. 7(B) shows the state of the scalar robot during execution of the mask-moving operation; and FIG. 7(C) shows the state of the scalar robot after it has terminated its mask-moving operation.

FIGS. 7(A) to 7(C) illustrate a case in which the mask 16 fixed to the mask-fixing arm 67 which has the shape of a cross and is attached to the arm base 64 is moved in a rightward direction as viewed in the figures. It should be noted that the example illustrates a case where a square glass substrate is used as a mask substrate.

In this case, first, the rotating mechanism 61 is rotated clockwise as viewed in the figure, and the first arm 62 is rotated clockwise as viewed in the figure in accordance with rotation of the rotating mechanism 61. At this time, the scalar robot shown in FIGS. 6(A) and 6(B) rotates the second motor 66 to thereby rotate the first timing belt 62a. The second timing belt 63a is rotated in a manner interlocked with the first timing belt 62a, and as shown in FIG. 7(B), the arm base 64 side of the second timing belt 63a is drawn toward the rotating mechanism 61. During this operation, the arm base 64 is rotated in a manner interlocked with the second timing belt 63a to move the mask 16 only in the rightward direction as viewed in the figure without being moved in the upward or downward direction as viewed in the figure. As a result, the mask 16 is linearly scanned at a focal position 70 of the optical system. From this state, when the rotating mechanism 61 is rotated, it is possible to further move the mask 16 in the rightward direction, as shown in FIG. 7(C).

As described hereinabove, the scalar robot shown in FIGS. 6(A) and 6(B) can move the mask 16 only in one direction.

By repeatedly carrying out the operation shown in FIGS. 7(A) to 7(C) while rotating the scalar robot, the confocal microscope 10 scans the whole surface of the mask 16.

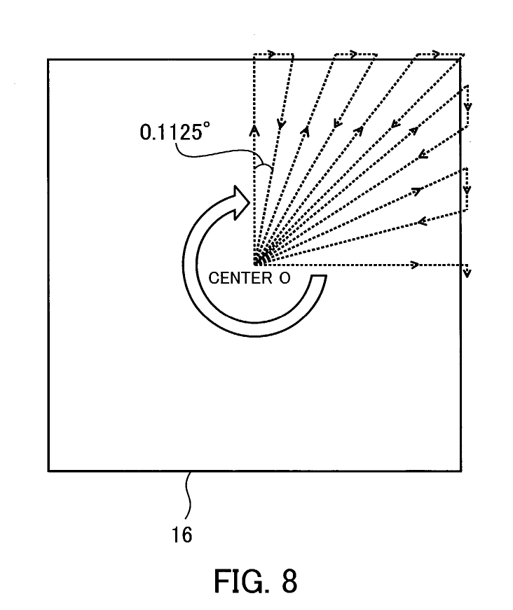

FIG. 8 is a diagram useful in explaining a method of scanning the surface of a mask.

When the mask 16 is scanned, first, it is scanned from the center O thereof toward an edge of a scanning area thereof. Then, after the focal position 70 of the optical system has reached the edge, the mask 16 is scanned while being rotated through 0.1125 degrees in the clockwise direction (125 μm in terms of length of a shift along the edge). From the reached point, the mask 16 is scanned again toward the center thereof. Thereafter, scanning is repeatedly carried out in a similar fashion to scan an area of 100 mm square.

The scalar robot constructed as above is thus moved only in directions of one linear reciprocation for every rotation through 0.1125 degrees. This makes it possible to move the mask 16 with excellent reproducibility, and further to locate the coordinates of the mask 16 with accuracy. Therefore, it is possible to scan the surface of the mask 16 accurately and conveniently.

Although the above description is given of the case where the confocal microscope 10 including the confocal optical system is used in the mask pattern inspection system, this is not limitative, but any suitable microscope can be used so long as it can take out an image signal indicative of light (color) having a specific wavelength.

Further, although the above description is given of the case in which Ta is used as a material of the absorber layer formed in the mask 16, this is not limitative but it is possible to employ ruthenium (Ru), tantalum nitride (TaN), chromium oxide (CrO₃), or the like in place of Ta.

Further, although in the example described above, the reflective mask is used as the mask 16, this is not limitative, the present invention can be applied to a transmissive mask to provide inspecting means using reflected light.

As described hereinabove, in the present invention, a defect-detecting image in which a defect candidate of the mask pattern has been detected, and an inspecting image (data item) obtained by converting pattern data in a manner adapted in condition to the defect-detecting image are compared with each other. This makes it possible to detect a defect candidate from the mask pattern with accuracy, and determine whether or not the detected defect candidate indicates a true defect.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A mask pattern inspection system for inspecting a mask pattern formed on a mask, comprising:
an optical system for irradiating white light emitted from a light source irradiating white light onto the mask and focusing reflected light from the mask;
an image-recording section for recording a defect-detecting image obtained from the reflected light focused by the optical system;
a defect candidate-detecting section for detecting a defect candidate from the defect-detecting image recorded in the image-recording section;
a pattern data-processing section for carrying out a filtering process on pattern data used for designing the mask to convert the pattern data to inspecting image data adapted in image condition to the defect-detecting image; and
an image comparison section for comparing the defect-detecting image and the inspecting image data with each other.

2. The mask pattern inspection system according to claim 1, wherein the optical system is a confocal optical system.

3. The mask pattern inspection system according to claim 1, wherein the defect candidate-detecting section extracts only a G signal from RGB signals included in the defect-detecting image to thereby detect the defect candidate.

4. The mask pattern inspection system according to claim 1, wherein the filtering process is carried out by using an FIR (Finite Impulse Response) filter.

5. The mask pattern inspection system according to claim 1, including a scalar robot for moving the mask horizontally to scan the mask with the white light.

6. A mask pattern-inspecting method for inspecting a mask pattern formed on a mask, comprising the steps of:
irradiating white light emitted from a light source onto the mask and focusing reflected light from the mask;
recording a defect-detecting image obtained from the reflected light;
detecting a defect candidate from the recorded defect-detecting image;
carrying out a filtering process on pattern data used for designing the mask to convert the pattern data to inspecting image data adapted in image condition to the defect-detecting image; and
comparing the defect-detecting image and the inspecting image data with each other.

7. The mask pattern-inspecting method according to claim 6, wherein the step of detecting a defect candidate from the recorded defect-detecting image includes extracting only a G signal from RGB signals included in the defect-detecting image, and when the G signal represents a gradation level lower than a predetermined gradation level for any site, this site is detected as a defect candidate.

8. The mask pattern-inspecting method according to claim 6, wherein the step of carrying out a filtering process on pattern data used for designing the mask to convert the pattern data to inspecting image data adapted in image condition to the defect-detecting image includes converting the pattern data to the inspecting image data adapted in image condition to the defect-detecting image by using an FIR filter.
